(19) United States
(12) Patent Application Publication
(10) Pub. No.: US 2018/0273804 A1
(43) Pub. Date: Sep. 27, 2018

(54) APPLICATION OF ADHESIVES

(71) Applicant: Zephyros, Inc.

(72) Inventors: Laurent Meistermann, Molsheim Cedex (FR); Eric Elkaim, Molsheim Cedex (FR)

(21) Appl. No.: 15/524,447

(22) PCT Filed: Nov. 20, 2015
(86) PCT No.: PCT/EP2015/077198

§ 371 Date: May 4, 2017

(30) Foreign Application Priority Data
Nov. 20, 2014 (GB) 1420627.0

(51) Int. Cl. C09J 5/06; C09J 5/08; C09J 123/08

(52) U.S. Cl. CPC C09J 5/06; C09J 167/00; C09J 123/0853; C09J 5/08

(57) ABSTRACT

Applying heat activatable adhesive to a substrate, the adhesive is solid at ambient temperature and can be melted at a temperature below its heat activation temperature wherein the adhesive formulation is supplied to a hot melt applicator where it is heated to above its melting point and below its activation temperature and the melt viscosity of the molten adhesive is controlled so that it can be ejected from the hot melt applicator onto a substrate to provide a coherent bead that adheres to the substrate and is dry to the touch on cooling and upon activation the adhesive is capable of expanding with a volume expansion greater than about 250%.

This application claims priority of GB 1420627.0, filed on Nov. 20, 2014.

The present invention relates to heat activatable and heat activated adhesives and in particular to the economic application of heat activatable foamable adhesives, to a substrate in particular the application of foamable adhesives with a high degree of expansion such as above about 250% as a bead of material which can subsequently be activated by heat to foam with a degree of expansion of greater than about 250%. Longitudinal beads of heat activatable adhesive are used in many industries to provide bond lines between substrates such as for example in the bonding together of substrates to form a component for an automobile. A bead of heat activatable adhesive is deposited on and adhered to a substrate at a temperature below the activation temperature of the adhesive and is subsequently activated at a higher temperature to bond two substrates together.

US 2004/0260012 A1 relates to a reactive hot melt composition which has adhesion and curing properties, and can be formulated into free-flowing pellets or beads, by using an ethylene-acrylic acid copolymer, and ethylene-methacrylic acid copolymer, and/or an ethylene-acrylic acid methacrylic acid terpolymer as a component of the composition along with free radical crosslinking initiators. The incorporation of a foaming agent enables the production of compositions which are useful in space-filling applications, (i.e., as so-called “anti-flutter” compositions). These adhesives may be expandable with a volume expansion of up to 250%.

GB 2 455 292 A discloses means for joining two surfaces that comprise providing a heat activated sealant at the end of one of the surfaces and inserting the end into a C or U shaped cup in the end of the other surface and heating to cause the sealant to flow and join the surfaces. Preferably the sealant is foamable. The sealant is particularly useful in the production of automobile hem flanges.

WO 2015/011686 relates to flexible films of thermosetting adhesive materials which are non-tacky to the touch, storage stable at room temperature and can be cured at elevated temperature with a short cure time and can be cured to produce a tough flexible adhesive layer including bonding to oily surfaces. The materials are particularly useful in bonding together dissimilar substrates.

It is known to apply activatable adhesives to a substrate so that the adhesive once applied may be activated at elevated temperature to cure, foam or a combination of both. High expansion adhesives may be applied in pumpable form as a paste but they suffer from the disadvantage that they remain tacky to the touch at ambient temperature requiring special handling techniques for the substrate carrying the activatable adhesive. It is also known to extrude activatable adhesives onto substrates. However extruders are expensive leading to high equipment costs which are not justified for low volume production runs for example in the production of materials for use in the manufacture of trucks or busses or railroad vehicles.

Where adhesives are applied manually they are usually applied as a paste which leads to inaccurate definition in the bead line and the need to use larger amounts of adhesive in order to be sure to obtain the desired bond. Hot melt guns are known and have been used for applying thermoplastics but have not been proposed for the application of molten heat expandable adhesives that may be activated for the production of high expansion adhesives since the heat involved in processing the melt of the adhesive formulation within the gun could cause premature foaming and/or curing of the adhesive.

Further, there is a demand for adhesive formulations that are heat activatable (heat expandable) and that can be applied to various substrates under conditions that prevent premature activation and that can subsequently be activated under various activation conditions that are realized for other reasons in the course of the manufacture of assembled articles automobiles and other vehicles, e.g. during automotive anticorrosion coating in bake ovens (e.g. bodyshop bakes or paintshop bakes). In this regard, it is particularly difficult to achieve high expansion levels (>500%) at comparatively high temperatures (>190° C.).

The invention addresses these issues and provides a simple economic process for the deposition of adhesive materials without activation to foam the adhesive during or after deposition and followed by expansion of the adhesive by heat. In this invention the adhesive once deposited on a substrate is dry and non-tacky to the touch and furthermore the adhesive can be solvent free and so avoid the formation of volatile organic compounds. It is also important that the adhesive has an activation cycle whereby foaming can be accomplished at a later activation stage perhaps at a different location. When the adhesive formulation is additionally curable, it is also important that the adhesive has a cure cycle whereby curing can be accomplished at a later activation stage perhaps at a different location.

One particular use of the adhesives according to the invention is on automobile components where the adhesive is used to foam and adhere to the components to produce seals and sound absorbing materials between components. The adhesive formulation is foamed with a high degree of expansion and optionally cured e.g. by the heat in the baking oven for the anticorrosion coat (e-coat) that is applied to the metal body of the automobile during assembly. In this embodiment it is important that the components provided with the adhesive are stackable and can be transported prior to assembly without activation of the adhesive and that they are not subject to any conditions prior to or during deposition of the adhesive or storage and transportation that impacts the ability of the adhesive to expand and optionally cure under the conditions in the baking oven.

If an adhesive is to be activated after deposition on a substrate perhaps some considerable time after deposition on the substrate it is important that there is no premature activation of the adhesive during formulation of the adhesive or during application of the adhesive. Particular difficulties arise if the adhesive is heat activated after application and also needs to be heated during application.

The present invention addresses these problems and provides the delivery of a heat curable and/or foamable adhesive on a substrate by a preferably hand held hot melt applicator, preferably by a hand held hot melt gun, followed by the expansion of the adhesive, wherein with a soft adhesive the adhesive is foamable and the volume expansion is greater than about 250%. In the invention application of the adhesive takes place under conditions where foaming does not take place. Foaming takes place after application in a subsequent step when the applied heat activatable adhesive is heat activated. The invention further provides an adhesive formulation that is used in such a delivery method together with the use of the adhesive formulation in such delivery.

The present invention therefore provides a process for the application of a heat activatable adhesive to a substrate wherein the heat activatable adhesive is solid at ambient temperature and can be melted at a temperature below its heat activation temperature wherein a particulate heat activatable adhesive formulation is supplied to a preferably hand held hot melt applicator, preferably by a hand held hot melt gun, wherein the heat activatable adhesive is heated to above its melting point and below its activation temperature and the melt viscosity of the molten adhesive is controlled whereby the molten adhesive can be or is ejected from the hot melt applicator onto a substrate to provide a coherent bead that adheres to the substrate and is dry to the touch on cooling.

We have found that the present invention allows the precise application of beads of thermally activatable materials which are heat curable and/or heat foamable at temperatures below that at which they are activated. Subsequent thermal activation may be foaming, and/or crosslinking or curing. In order to foam under the action of heat the material will contain a blowing agent which generates the gas required to cause foaming at an activation temperature. The techniques of the present invention deliver the material onto the substrate at a temperature at which it will adhere to the substrate but which is below that at which the blowing agent is activated. Similarly if the material is thermohardenable and hardening is caused by the activation of a curing agent within the adhesive formulation the techniques deliver the material at a temperature at which it will adhere to a substrate but which is below that at which the curing agent is activated.

The invention is therefore particularly useful for the provisions of a pattern or array particularly a continuous bead of a thermoactivatable material on a substrate for subsequent activation. The adhesive may be foamable and may produce soft materials useful as sealants, anti-flutter materials and baffles for sound baffling. The adhesives may contain crosslinking agents (curing agents) which are activated by heat. The desired pattern or array of the adhesive material can be applied according to this invention in an unfoamed and optionally uncured state ready for foaming and optionally curing during the subsequent automotive assembly operation. The techniques are equally useful in other industries such as aircraft, railroad vehicles, furniture and the construction industry.

With the adhesive formulation that is applied in accordance with the invention it is possible to reach high volume expansion (e.g. 500% and more) in order to allow filling large cavities and gaps thus achieving improved acoustic damping properties. The expanded adhesive provides improved body acoustic, anti-flutter and sealing properties and good corrosion resistance. The adhesive formulation in its green state (i.e. prior to heat activation but after melt application) has good green strength adhesion, particularly to degreased cold metal, thereby providing the applied bead to resist wash out. Further, on cooling the applied bead is dry to the touch. It is possible to apply the molten adhesive to metal substrates without preheating of substrates.

The adhesive formulation can be applied by means of simple equipment (hot melt applicator), preferably by means of a hand held hot melt gun, and does not require pump or extruder. When the hot melt applicator is equipped with a cartridge system, the hot melt applicator does not need a purging of the adhesive formulation in comparison to conventional melt pump or extruder when the adhesive formulation needs to be stop for a time longer than the adhesive reaction time.

Preferably, the adhesive formulation is provided in cartridges that are compatible with the hot melt applicator and that can optionally be heated prior to application by means of a commercial preheater. Typical cartridge preheating conditions are about 10 minutes to about 30 minutes at temperatures of about 70° C. to about 100° C. A skilled person recognizes that under these conditions the adhesive formulation is provided in the cartridge in form of a particulate material (powder, micro-pellets, pellets or bulk material), but that in the course of preheating it may be melted such that when the cartridge is subsequently transferred to the hot melt applicator, the adhesive may be delivered to the hot melt applicator in a melted state already. For the purpose of the specification, the delivery of the particulate adhesive to the hot melt applicator encompasses the preceding delivery to a preheater and the subsequent delivery of an optionally melted adhesive formulation to the hot melt applicator. The adhesive formulation may be contained in the cartridge in form of a powder, micro-pellets, pellets or as bulk material. When the cartridges are filled with bulk material (no pellets), it may take a longer time to melt the material. The disadvantage is that the open time for application will be reduced because the material will be subjected to heat a longer time before dispensing. This can be disadvantageous in order to suppress premature heat activation. Thus, in a preferred embodiment, the cartridges are filled with a particulate material that is preferably provided in form of particles or pellets that can be melted quickly and hence can be used without any disadvantage during an extended open time window without premature heat activation.

Preferably, the hot melt applicator is equipped with a nozzle having a diameter of about 2 mm to about 8 mm.

Preferably, immediately prior to its application to a substrate, the heat activatable adhesive is heated to a temperature within the range of about 90° C. to about 115° C.

The materials being applied according to the present invention may be adhesive materials, sealant materials, weldable materials, weld-through materials, paintable materials or other suitable flowable materials. In one highly preferred embodiment, the materials may be treated or otherwise processed for the application of additional materials which facilitate and allow the formation of a class A painted surface finish, or other class of painted or treated surface, upon the flowable material.

The adhesive formulation delivered to the hot melt applicator, preferably by a hand held hot melt gun, according to this invention may be in form of pellets, micro-pellets or may be powdered. Alternatively, the material may be in form of a bulk material, i.e. a mass that may be congealed and/or monolithic and provided e.g. in a cartridge. For the purpose of the specification, the term “particulate” preferably also encompasses a bulk material such as a solid monolithic congealed mass.

When the adhesive formulation according to the invention is in powder form, it may have an average particle size within the range of from about 20 μm to about 250 μm, preferably of at least about 20 μm, and less than about 200 μm, preferably having an average particle size of at least about 25 μm and less than about 125 μm. The powdered adhesive may be obtained by grinding pellets of the adhesive formulation until they will pass through an appropriate sized mesh.

Alternatively, when the adhesive formulation according to the invention is in the form of micro-pellets, the micro-pellets preferably have an average particle size of from about 250 μm to about 1000 μm, or about 250 μm to about 750 μm, more preferably about 300 μm to about 1000 μm, or about 300 μm to about 750 μm.

Alternatively, when the adhesive formulation according to the invention is in the form of pellets, the pellets preferably have an average particle size of from about 1000 μm to about 6000 μm, or preferably from about 1000 μm to about 5000 μm, more preferably from about 3000 μm to about 6000 μm, or from about 3000 μm to about 5000 μm.

Suitable methods to measure the average particle size are known to the skilled artisan and include laser diffraction and image analysis. Preferably, for the purpose of the specification, the “average particle size” is expressed in terms of the geometric mean value D[4,3] with the volume as the basis for the distribution calculation (volume distribution) in accordance with ASTM E 799. In a preferred embodiment, the particle size is measured using a laser particle size meter, preferably with the powder dispersed in deionized water.

The heat activatable material that is delivered according to the present invention is an expandable polymeric formulation or composition, that is activated to foam, and optionally cure on the substrate when exposed to the heating operation of a typical automotive painting operation such as during a primer or paint drying step. One preferred material particularly for forming seals and baffles is formed of an olefinic polymer-based foam, and more particularly an ethylene based polymer and here foamable adhesives with a degree of volume expansion greater than about 250% are used. The preferred polymeric foam is based on ethylene copolymers or terpolymers. Examples of particularly preferred polymers include ethylene vinyl acetate copolymers, elastomers such as EPDM, ethylene acrylate copolymers such as ethylene butyl acrylate copolymers or a mixture thereof. Such materials may exhibit properties including sound absorption, vibration absorption, sealing ability, corrosion resistance and the like.

In applications where a heat activatable, thermally expanding material is employed, a consideration involved with the selection and formulation of the material is to achieve the desired balance between the melt temperature employed in the hot melt applicator and the temperature at which subsequent post-delivery activation such as expansion, and possibly curing of the material, will take place. In one embodiment, the material is delivered onto the substrate by a supplier according to this invention and then the coated substrate is shipped to the vehicle manufacturer as an integrated product which is incorporated in the vehicle production line and the adhesive then activated to foam and optionally cure. Accordingly the melt flowable material is activated at processing temperatures higher than the melt delivery temperature, such as those encountered in an automobile assembly plant, when the material is processed along with the vehicle components at elevated temperatures or at higher applied energy levels, e.g., during e-coat preparation steps and other paint cycles. While temperatures encountered in an automobile e-coat operation may be in the range of about 145° C. to about 210° C. (about 300° F. to 400° F.), primer, filler and paint shop applications are commonly about 100° C. (about 200° F.) or higher. The material is thus activated within these ranges. If needed, blowing agent activators can be incorporated into the composition to cause expansion at the required temperatures.

Generally, suitable expandable adhesive materials for the production of seals and sound insulating baffles have a range of volumetric expansion from about 250% to over about 2000% depending upon the function required of the foam. The level of expansion of acoustic barrier or vibration reduction material may be as high as about 500% or as high as about 1000%, typically as high as about 2500%, or as high as about 3000%, or even as high as about 5000% or more. In certain embodiments, the material may be hyper-expandable materials that expand more than about 1500% such as over about 2000%. Preferably, the adhesive has a range of volumetric expansion of at least about 300%, preferably at least about 350%, especially at least about 400%. The level of expansion depends upon the nature and the amount of blowing agent that is contained in the adhesive formulation and can be determined by simple routine testing. The level of expansion can also be influenced by the optional presence of a blowing agent accelerator. In order to achieve volumetric expansion of more than about 250%, the content of blowing agent typically amounts to at least about 3 wt %, at least about 4 wt % or more than about 4 wt.-%, at least about 4.5 wt %, or more, based on the total weight of the adhesive formulation.

As discussed particularly for automotive operations, it is desirable for the materials used in the present invention to activate at temperatures experienced during automobile paint cycles. Prior to activation, however, it is often preferable for the materials to exhibit solid and substantially non-tacky characteristics at temperatures near room temperature (e.g., between about 5° C. and about 50° C.). They should however exhibit flow and tackiness without activation at mid-level temperatures (e.g., between about 50° C. and about 120° C., typically from 85° C. to about 115° C.) so that the materials can be heated to mid-level temperatures within the hand held melt flow applicator (hot melt applicator, hot melt gun) to allow the materials to flow within the applicator and be delivered to and adhere to a substrate.

Preferably, the hot melt applicator is a hand held hot melt gun. Typical conditions employed in a hot melt gun applicator is a feed of powder or pellets at ambient temperature, with the temperature of the barrel of the gun set at a temperature in the range of about 85° C. to about 115° C. and applying a pressure of from about 2 bars to about 8 bars, preferably from about 5 bars to about 7 bars, to deliver the material from the gun onto a substrate.

Preferably, the adhesive formulation has a viscosity at 100° C. with a shear rate of 100 s⁻¹ in the range of about 50 Pa·s to about 500 Pa·s and with a shear rate of 0.1 s⁻¹ in the range of about 1000 Pa·s to about 10,000 Pa·s. Preferably, the adhesive formulation has a viscosity at 100° C. with a shear rate of 100 s⁻¹ of not more than about 500 Pa·s, or not more than about 480 Pa·s, or not more than about 460 Pa·s, or not more than about 440 Pa·s, or not more than about 420 Pa·s, or not more than about 400 Pa·s.

We have found that the inclusion of a base resin with a narrow molecular weight distribution is preferably included in the formulation for achieving these desired viscometrics. The molecular weight distribution is preferably such that about 70% of the polymers in the base resin are within about 10,000 atomic mass units (amu) of each other, more preferably about 80% of the polymers in the base resin are within about 5000 amu of each other and even more preferably about 90% of the polymers are within about 1000 amu of each other. Preferably, the base resin comprises about 50 wt % to about 100 wt % of the material or of the polymeric constituents of the material, and more preferably about 60 wt % to about 90 wt % of the material or of the polymeric constituents of the material, relative to the total weight of the base resin.

In a preferred adhesive formulation for use in this invention to produce foamed seals and sound insulating baffles the desired melt viscosity of the formulation is achieved by the use of polymers together with cross linking agents which are activated at temperatures within the gun to control the melt viscosity. In particular we prefer to use ethylene copolymers with polar comonomers such as ethylene vinyl acetate copolymers or ethylene acrylate copolymers such as ethylene butyl acrylate copolymers.

We prefer to use copolymers with a high content of ester comonomer such as copolymers containing from about 25 wt % to about 50 wt % comonomer, more preferably from about 30 wt % to about 46 wt % comonomer and also which melt at a temperature in the range of about 60° C. to about 85° C., preferably about 60° C. to about 75° C.

In a preferred embodiment, the adhesive formulation according to the invention comprises a reactive elastomeric terpolymer of ethylene with a first comonomer selected from alkyl acrylates and alkyl methacrylates, and with a second comonomer selected from glycidyl acrylate and glycidyl methacrylate. Preferably, the content of said reactive elastomeric ethylene terpolymer is within the range of from about 1.0 wt % to about 10 wt %, more preferably about 2.0 wt % to about 8.0 wt %, and most preferably about 3.0 wt % to about 6.0 wt %, relative to the total weight of the adhesive formulation.

In a particularly preferred embodiment, the adhesive formulation according to the invention comprises a terpolymer of ethylene/butyl acrylate/glycidyl methacrylate (reactive elastomeric ethylene terpolymer).

In preferred embodiments, the adhesive formulation that is delivered according to the invention comprises
(i) one or more copolymer of ethylene and butyl acrylate, wherein the relative content of butyl acrylate is preferably within the range of from about 20 wt % to about 50 wt %, more preferably about 25 wt % to about 45 wt %, still more preferably about 30 wt % to about 40 wt %, relative to the total weight of the copolymer of ethylene and butyl acrylate; and wherein the overall content of said one or more copolymer of ethylene and butyl acrylate is preferably within the range of from about 20 wt % to about 60 wt %, more preferably about 25 wt % to about 55 wt %, and most preferably about 28 wt % to about 50 wt %, relative to the total weight of the adhesive formulation; and/or
(ii) one or more copolymer of ethylene and vinyl acetate, wherein the relative content of vinyl acetate is preferably within the range of from about 15 wt % to about 45 wt %, more preferably about 20 wt % to about 40 wt %, still more preferably about 25 wt % to about 35 wt %, relative to the total weight of the copolymer of ethylene and vinyl acetate; and wherein the overall content of said one or more copolymer of ethylene and vinyl acetate is preferably within the range of from about 2.0 wt % to about 20 wt %, more preferably about 5.0 wt % to about 15 wt %, and most preferably about 8.0 wt % to about 13 wt %, relative to the total weight of the adhesive formulation; and/or
(iii) one or more terpolymer of ethylene/butyl acrylate/glycidyl methacrylate, wherein the overall content of said one or more terpolymer of ethylene/butyl acrylate/glycidyl methacrylate is preferably within the range of from about 1.0 wt % to about 10 wt %, more preferably about 2.0 wt % to about 8.0 wt %, and most preferably about 3.0 wt % to about 6.0 wt %, relative to the total weight of the adhesive formulation; and/or
(iv) one or more reactive hydroxylated polyester resin; wherein the overall content of said one or more reactive hydroxylated polyester resin is preferably within the range of from about 2.0 wt % to about 20 wt %, more preferably about 5.0 wt % to about 12 wt %, and most preferably about 6.0 wt % to about 11 wt %, relative to the total weight of the adhesive formulation.

Cross linking agents such as peroxides are also included to control melt viscosity and the sagging (undesirable melt flow) of the polymers as they are applied to the substrate in the melt. We prefer to include from about 1 wt % to about 5 wt % of peroxide cross linking agent based on the weight of ethylene copolymers in the formulation.

In a preferred embodiment, the adhesive formulation according to the invention neither contains ehylene/acrylic acid copolymers nor divinylbenzene/butadiene copolymers.

In one embodiment, the formulation includes one or more solubilizing agents, which assist the delivered molten material in solubilizing contaminants on a substrate surface. Examples of such solubilizing agents include hydrocarbons (e.g., hydrocarbon process oils), phthalate plasticizers, liquid polyolefins or the like. Preferably, when used, such solubilizing agents are between about 1 wt % and about 30 wt % of the flowable material, more preferably between about 5 wt % and about 20 wt % of the flowable material.

In another embodiment, the formulation may include one or more polar components, which can aid in adhesion of the material to the substrate. Preferably, such components have relatively low melting points (e.g., between about 50° C. and about 100° C.). Examples of such components include oxidized or otherwise functionalized waxes, petroleum resins, resin esters or combinations thereof. Preferably, when used, such polar components are between about 1 wt % and about 30 wt % of the formulation, more preferably between about 2 wt % and about 15 wt % of the formulation.

In still another embodiment, the formulation includes one or more components such as waxes that are modified with an adhesion promoter such as an acid anhydride group. Preferably, when used, such modified components are about 1 wt % and about 30 wt % of the flowable material, more preferably between about 5 wt % and about 20 wt % of the flowable material.

All the adhesive formulations to which this invention is applicable may also include one or more fillers, including but not limited to particulated materials (e.g., powder), beads, microspheres, or the like. The precursor layer may also be substantially free of any filler material. Fillers can be useful to reduce any blocking tendency of the unfoamed adhesive powder, reduce cost, and reduce the coefficient of thermal expansion of the activated material. The precursor layer may include a filler that comprises less than about 25 wt % of the precursor material. Ideally, the filler may comprise less than about 2.5 wt % of the precursor layer. Any filler present may include a material that is generally non-reactive with the other components present in the precursor layer. Certain fillers can also reduce the tendency of the particles to agglomerate as well as reducing the blocking tendency.

Examples of suitable fillers include silica, diatomaceous earth, glass, clay (e.g., including nanoclay), talc, pigments, colorants, glass beads or bubbles, glass, carbon or ceramic fibers, nylon aramid or polyamide fibers (e.g., Kevlar), antioxidants, and the like. Such fillers, particularly clays, can assist the activatable material in leveling itself during flow of the material. The clays that may be used as fillers may include clays from the kaolinite, illite, chloritem, smecitite or sepiolite groups, which may be calcined. Examples of suitable fillers include, without limitation, talc, vermiculite, pyrophyllite, sauconite, saponite, nontronite, montmorillonite or mixtures thereof. The clays may also include minor amounts of other ingredients such as carbonates, feldspars, micas and quartz. The fillers may also include ammonium chlorides such as dimethyl ammonium chloride and dimethyl benzyl ammonium chloride. Titanium dioxide might also be employed.

In one embodiment it is preferred to include a thixotropic filler such as aramid fibre or certain clays in the adhesive formulation used in this invention. The inclusion of such a thixotropic filler can reduce the tendency of the adhesive formulation to flow and sag when it is a fluid state or when it is heated to the activation temperature.

The adhesive formulations that are delivered according to the present invention may be foamable and they may contain a heat activatable blowing agent for example one that decomposes to produce gas at temperatures above the melt application temperature such as temperatures experienced in the automotive anticorrosion coating bake oven. Typically temperatures are in the range of about 150° C. to about 220° C. (typical bodyshop bakes) or in the range of about 80° C. to about 150° C. (typical paintshop bakes). The blowing agent is compatible with the other components and capable of expanding or decomposing on heating, such as when the formulation is activated, in order to lower the density of the final material. A blowing agent accelerator which reduces the temperature at which gas is liberated by the blowing agent may also be included. Zinc oxide is an example of a suitable blowing agent accelerator.

Examples of suitable blowing agents include chemical blowing agents (e.g., those agents that provide for material expansion via a chemical reaction) comprising but not limited to azo compounds, such as azodicarbonamide, azodiisobutyro-nitrile, barium azodicarboxylate; nitroso compounds such as N,N′-dimethyl-N,N′-dinitrosoterephthalamide, dinitrosopentamethylenetetramine; hydrazides such as benzenesulfonhydrazide, p,p-oxybis (benzenesulfonylhydrazide), trihydrazinotriazine; carbazides, such as 4,4-oxybenzene sulfonyl semicarbazide, p-toluene sulfonyl semicarbazide; triazines such as trihydrazino triazine; and reactive couples such as mixtures of citric acid and sodium bicarbonate. Such materials may be used singly or in combinations of two or more thereof. Suitable commercially available blowing agents include products sold under the names HYDROCEROL® (from Boehringer Ingelheim), CELOGEN® OT, AZ, AZNP, and RA (from Crompton), FICEL®, GENITRON® and PLANAGEN® (from Bayer), and SAFOAM® FP, RPC and RIC FP (from Reed International Corporation). Preferred blowing agents are p,p-oxybis(benzenesulfonylhydrazide) (for example, CELOGEN® OT) and azodicarbonamide (for example, CELOGEN® AZ).

The blowing agent may also be a physical blowing agent, such that material expansion occurs via a phase change mechanism. Physical blowing agents can comprise a volatile gas trapped in a thermoplastic shell which softens and lets the gas expand at the foaming temperature. An example of such a blowing agent in sold under the trade name Expancel, sold by Akzo Nobel, Sundsvall, Sweden.

When a cross linking agent is included to cross link the foam the blowing agent may be selected to generate gases for foaming at around the activation temperature of the cross linking agent. It is preferred that the crosslinking agent will cure the adhesive during foam formation so that the molten formulation is sufficiently viscous to entrap the gas produced by the decomposition of the blowing agent. When the formulations to produce soft foams useful for seals and sound transmission barriers they should contain sufficient blowing agent to cause the desired degree of expansion (greater than about 250%) in the time and at the temperature to which the material is exposed, for example in the automotive anticorrosion coating bake oven.

The hand held melt applicator used in this invention may be any well known hand held devices such as a pump action or pressure applicator in which the adhesive formulation is converted into a flowable state within the applicator and expelled from the applicator onto the substrate to deliver an adhesive layer on the substrate. The adhesive layer may be continuous or discontinuous and may be in a predetermined pattern. We have found that the invention allows the heat activatable adhesive to be readily applied by hand to provide an accurate deposit, such as a continuous or discontinuous bead of a heat activatable adhesive on the substrate which may be subsequently activated at elevated temperature and is not tacky to the touch at ambient temperature upon cooling after delivery.

The present invention is particularly useful in providing adhesives in the automobile, aircraft and furniture industries particularly in automotive body repair shops and in low volume assembly lines such as in the manufacture of trucks and busses.

If necessary the substrate may be cooled when the adhesive is being applied. Cooling may enhance the bond between the adhesive and the substrate and it may also reduce the likelihood of premature activation of the adhesive. Although we have found that generally this is not necessary. Alternatively, the substrate may be heated.

In a preferred embodiment, the surface of the substrate is pretreated prior to application of the adhesive formulation according to the invention. Pollution of the surface can be reduced when the material, e.g. the metal, is cold. Oily surfaces are preferably degreased chemically and/or physically. The surface may be equipped with primers or adhesion promoters, although less preferred.

In another preferred embodiment, the surface of the substrate is preheated and the adhesive formulation is applied without additional surface preparation. The preheating may be performed by means of conventional heating equipment including but not limited to IR lamps, hot air blow systems, heat resistance, plasma, and the like. After preheating of the surface of substrate, it may allow to cool down to ambient temperature or alternatively, the adhesive formulation may be applied to the surface of the substrate at elevated temperature of the surface of the substrate.

In a preferred embodiment, the substrate is a metal substrate or comprises metal. Preferably, the metal comprises steel, aluminum, and/or magnesium.

In a preferred embodiment, the substrate comprises a polymer and/or a composite material. Preferably, the polymer and/or composite material is selected from the group consisting of polyamides, fiber reinforced plastics (FRP), thermosets, bulk molding compounds (BMC), sheet molding compounds (SMC), and prepregs.

Preferably, the substrate has ambient temperature.

Preferably, the molten adhesive is applied to the substrate at an angle of application within the range of about 45° to about 90°.

The adhesive formulation may be delivered in several stages so that the thickness of the activation layer adhesive is increased. The hand held delivery may be repeated in one or more specific areas of the substrate so that the thickness of the film of activatable adhesive is increased in the one or more specific areas. Alternatively, a second composition can be applied to the first composition. This could be of interest for example to tailor the adhesive for maximum performance should two different substrates be bonded. Additionally the adhesive can be applied to selected areas of the substrate. The adhesive formulation is preferably storage stable for at least six months, more preferably at least one year.

The present invention may be used to apply adhesives to any substrate and may be used for the bonding together of a range of substrates. For example the adhesive may be used to bond together metal substrates such as in vehicle manufacture. It may be used in the bonding of different substrates such as the bonding of metal to fiber reinforced composites.

Another aspect of the invention relates to a particulate heat activatable adhesive formulation according to the invention as described above, which is solid at ambient temperature and can be melted at a temperature below its heat activation temperature, for providing a coherent bead of the adhesive onto a substrate by means of a hot melt applicator, wherein the coherent bead adheres to the substrate and is dry to the touch on cooling, and preferably wherein upon activation the adhesive is capable of expansion when heated with a volume expansion greater than 250%, wherein the adhesive formulation according to the invention comprises
(i) one or more copolymer of ethylene and butyl acrylate, wherein the relative content of butyl acrylate is within the range of from about 20 wt % to about 50 wt %, more preferably about 25 wt % to about 45 wt %, still more preferably about 30 wt % to about 40 wt %, relative to the total weight of the copolymer of ethylene and butyl acrylate; and wherein the overall content of said one or more copolymer of ethylene and butyl acrylate is preferably within the range of from about 20 wt % to about 60 wt %, more preferably about 25 wt % to about 55 wt %, and most preferably about 28 wt % to about 50 wt %, relative to the total weight of the adhesive formulation;
(ii) one or more copolymer of ethylene and vinyl acetate, wherein the relative content of vinyl acetate is within the range of from about 15 wt % to about 45 wt %, more preferably about 20 wt % to about 40 wt %, still more preferably about 25 wt % to about 35 wt %, relative to the total weight of the copolymer of ethylene and vinyl acetate; and wherein the overall content of said one or more copolymer of ethylene and vinyl acetate is preferably within the range of from about 2.0 wt % to about 20 wt %, more preferably about 5.0 wt % to about 15 wt %, and most preferably about 8.0 wt % to about 13 wt %, relative to the total weight of the adhesive formulation; and
(iii) one or more terpolymer of ethylene/butyl acrylate/glycidyl methacrylate, wherein the overall content of said one or more terpolymer of ethylene/butyl acrylate/glycidyl methacrylate is preferably within the range of from about 1.0 wt % to about 10 wt %, more preferably about 2.0 wt % to about 8.0 wt %, and most preferably about 3.0 wt % to about 6.0 wt %, relative to the total weight of the adhesive formulation; and
(iv) optionally, one or more reactive hydroxylated polyester resin; wherein the overall content of said one or more reactive hydroxylated polyester resin is preferably within the range of from about 2.0 wt % to about 20 wt %, more preferably about 5.0 wt % to about 12 wt %, and most preferably about 6.0 wt % to about 11 wt %, relative to the total weight of the adhesive formulation.

All preferred embodiments that have been described above in relation to the process according to the invention analogously apply to the adhesive formulation according to the invention and thus are not repeated hereinafter.

Another aspect of the invention relates to the use of the particulate heat activatable adhesive formulation according to the invention as described above, which is solid at ambient temperature and can be melted at a temperature below its heat activation temperature, for providing a coherent bead of the adhesive onto a substrate by means of a hot melt applicator, wherein the coherent bead adheres to the substrate and is dry to the touch on cooling, and preferably wherein upon activation the adhesive is capable of expansion when heated with a volume expansion greater than 250%. Preferably, the particulate heat activatable adhesive formulation according to the invention is used in the process according to the invention as described above.

All preferred embodiments that have been described above in relation to the particulate heat activatable adhesive formulation according to the invention and the process according to the invention, respectively, analogously apply to the use according to the invention and thus are not repeated hereinafter.

Another aspect of the invention relates to a cartridge for a hot melt applicator, preferably a hand held hot melt gun, which cartridge comprises the adhesive formulation according to the invention.

Another aspect of the invention relates to a substrate comprising at its surface a coherent bead of the adhesive formulation (melted and subsequently congealed adhesive material) that adheres to the substrate and is dry to the touch on cooling and wherein upon activation the adhesive is capable of expansion when heated with a volume expansion greater than about 250%.

Another aspect of the invention relates to a substrate comprising at its surface an expanded, i.e. heat activated adhesive material according to the invention.

All preferred embodiments that have been described above in relation to the process according to the invention, the particulate heat activatable adhesive formulation according to the invention, and its use according to the invention, analogously apply to the cartridge and the substrates according to the invention and thus are not repeated hereinafter.

The invention is illustrated by reference to the following Example.

A formulation suitable for the production of soft foam seals and sound barriers and comprising the following materials:

| | wt % |
|---|---|
| random copolymer of ethylene and butyl acrylate (35 wt %) | 20 to 35 |
| random copolymer of ethylene and butyl acrylate (35 wt %) | 8 to 15 |
| copolymer of ethylene and vinyl acetate (28 wt %) | 8 to 13 |
| reactive elastomeric ethylene terpolymer | 3 to 6 |
| reactive hydroxylated polyester resin | 6 to 11 |
| hydrocarbon resin | 7 to 10 |
| filler | 10 to 20 |
| peroxide crosslinking agent | 0.7 to 1.6 |
| benzoyl peroxide | 0.4 to 1 |
| dipentaerythritol pentaacrylate (curing agent) | 0.5 to 1.8 |
| azodicarbonic acid diamide preparation (blowing agent) | 3 to 5 |
| blowing agent accelerator | 1.5 to 3 |
| | 100.00 |

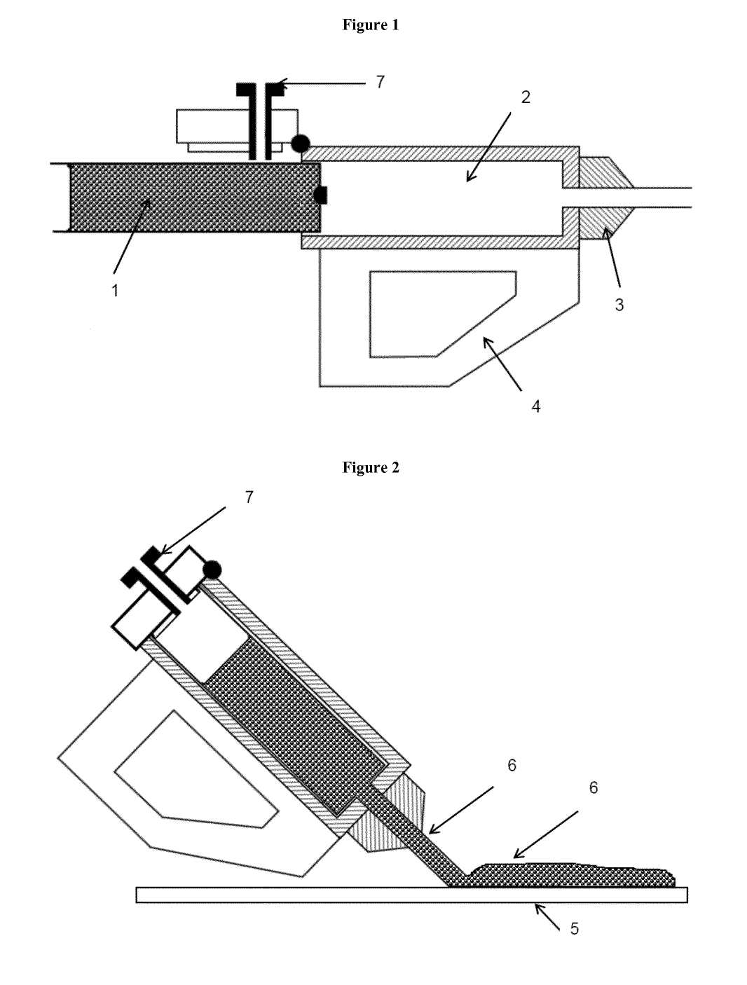

was blended and pelletized. The pellets were fed to a hand held hot melt gun such as shown in FIG. 1. The melt temperature of the gun was set at 100° C.

The polymers have a high ester co monomers (vinyl acetate or butyl acrylate) content to provide polymers with a low melt temperature and good adhesion properties (high polarity).

The use of the peroxide cross linking agent controls the sagging behavior of the formulation (low viscosity and low Tₘₑₗₜ polymers), and also controls the crosslinking density and reactivity of the formulation.

The material (1) was fed to the barrel (2) of the hot melt gun provided with a handle (4). It was then delivered from the nozzle (3) of the hot melt gun (1) onto a surface (5) as a continuous bead (6) by applying pressure from the plunger (7) as is shown in FIG. 2. The bead was dry to the touch on cooling. The material could be foamed by as much as 1000% in the automobile e-coat oven where it is heated to about 150° C. for about 30 minutes.

1. A process for the application of a heat activatable adhesive to a substrate, wherein the heat activatable adhesive is solid at ambient temperature and can be melted at a temperature below its heat activation temperature,
wherein a particulate heat activatable adhesive formulation is supplied to a hot melt applicator,
wherein the heat activatable adhesive is heated to above its melting point and below its activation temperature,
wherein the melt viscosity of the molten adhesive is controlled whereby the molten adhesive is ejected from the hot melt applicator onto a substrate to provide a coherent bead that adheres to the substrate and is dry to the touch on cooling and wherein upon activation the adhesive is capable of expansion when heated with a volume expansion greater than about 250%.

2. The process according to claim 2, wherein the hot melt applicator is a hand held hot melt gun.

3. The process according to claim 1 or 2, wherein the hot melt applicator is equipped with a nozzle having a diameter of about 2 mm to about 8 mm.

4. The process according to claim 1, wherein the heat activatable adhesive is heated to a temperature within the range of about 90° C. to about 115° C.

5-9. (canceled)

10. The process according to claim 1, wherein the molten adhesive is applied to the substrate at an angle of application within the range of about 45° to about 90°.

11. The process according to claim 4, wherein the adhesive is thermohardenable and hardening is caused by the activation of a heat activatable curing agent within the adhesive formulation.

12. The process according to claim 1 for the provisions of a pattern or array or a continuous bead of a thermoactivatable material on a substrate for subsequent activation.

13. The process according to claim 4, wherein the coherent bead that adheres to the substrate is subsequently activated at a temperature in the range of about 80° C. to about 150° C. thereby expanding the heated adhesive with a volume expansion greater than about 250%.

14. The process according to claim 4, wherein the coherent bead that adheres to the substrate is subsequently activated at a temperature in the range of about 150° C. to about 220° C. thereby expanding the heated adhesive with a volume expansion greater than about 250%.

15. The process according to claim 1, wherein the adhesive formulation is in the form of a powder with an average particle size of from about 20 μιη to about 250 μιη.

16. The process according to claim 4, wherein the adhesive formulation is in the form of micro-pellets with an average particle size of from about 250 μιη to about 1000 μιη.

17. The process according to claim 4, wherein the adhesive formulation is in the form of pellets with an average particle size of from about 1000 μιη to about 6000 μιη.

18-19. (canceled)

20. The process according to claim 1, wherein the adhesive formulation contains a blowing agent selected from chemical blowing agents and physical blowing agents.

21-24. (canceled)

25. The process according to claim 1 in which the hot melt applicator comprises a barrel that is set at a temperature in the range of about 85° C. to about 115° C. and a pressure of from about 2 bars to about 8 bars, preferably about 5 bars to about 7 bars, such that the molten adhesive is delivered from the hot melt applicator onto a substrate.

26. The process according to claim 1, wherein the adhesive formulation has a viscosity at 100° C. with a shear rate of 100 s″¹ in the range of about 50 Pa-s to about 500 Pa-s and with a shear rate of 0.1 s″¹ in the range of about 1000 Pa-s to about 10,000 Pa-s.

27. The process according to claim 1, wherein the adhesive formulation contains a base resin with a narrow molecular weight distribution such that 70% of the polymers in the base resin are within 10,000 atomic mass units (amu) of each other.

28. The process according to claim 1, wherein the melt viscosity of the adhesive formulation is controlled by the use of polymers together with one or more cross linking agents which are activated at temperatures within the hot melt applicator to control the melt viscosity.

29-30. (canceled)

31. A particulate heat activatable adhesive formulation, which is solid at ambient temperature and can be melted at a temperature below its heat activation temperature, for providing a coherent bead of the adhesive onto a substrate by means of a hot melt applicator, wherein the coherent bead adheres to the substrate and is dry to the touch on cooling and wherein upon activation the adhesive is capable of expansion when heated with a volume expansion greater than about 250%, wherein the particulate heat activatable adhesive formulation comprises
(i) one or more copolymer of ethylene and butyl acrylate, wherein the relative content of butyl acrylate is preferably within the range of from about 20 wt % to about 50 wt %;
(ii) one or more copolymer of ethylene and vinyl acetate, wherein the relative content of vinyl acetate is preferably within the range of from about 15 wt % to about 45 wt %; and
(iii) one or more terpolymer of ethylene/butyl acrylate/glycidyl methacrylate; and
(iv) optionally, one or more reactive hydroxylated polyester resin.

32. The adhesive formulation according to claim 31, wherein
(i) the overall content of said one or more copolymer of ethylene and butyl acrylate is within the range of from about 20 wt % to about 60 wt %, relative to the total weight of the adhesive formulation; and/or
(ii) the overall content of said copolymer of ethylene and vinyl acetate is within the range of from about 2.0 wt % to about 20 wt %, relative to the total weight of the adhesive formulation; and/or
(iii) the overall content of said one or more terpolymer of ethylene/butyl acrylate/glycidyl methacrylate is within the range of from about 1.0 wt % to about 10 wt %; and/or
(iv) the overall content of said optionally present one or more reactive hydroxylated polyester resin is within the range of from about 2.0 wt % to about 20 wt %, relative to the total weight of the adhesive formulation.

33. The adhesive formulation according to claim 31, which is in the form of a powder with an average particle size of from about 20 μιη to about 6000 μιη.

34-45. (canceled)
